(19) United States
(12) Patent Application Publication
(10) Pub. No.: US 2010/0140091 A1
(43) Pub. Date: Jun. 10, 2010

(54) INTEGRATED ELECTROPHORESIS DEVICE AND OPERATION THEREOF

(75) Inventors: An-Bang Wang, Taipei City (TW); Chia-Wei Cheng, Taipei City (TW); I-Chun Lin, Taipei City (TW); Chun-Hui Yang, Taipei City (TW); Po-Ting Pan, Taipei City (TW); Chen-Chi Kuan, Taipei City (TW); Yen-Chih Chen, Taipei City (TW); Yi-Wei Lin, Taipei City (TW); Fei-Yau Lu, Taipei City (TW)

Correspondence Address: QUINTERO LAW OFFICE, PC, 615 Hampton Dr, Suite A202, Venice, CA, 90291, US

(73) Assignee: NATIONAL TAIWAN UNIVERSITY, Taipei (TW)

(21) Appl. No.: 12/370,408

(22) Filed: Feb. 12, 2009

(30) Foreign Application Priority Data
Dec. 9, 2008 (TW) TW097147812

(51) Int. Cl. B01D 57/02; G01N 27/447

(52) U.S. Cl. 204/468; 204/606; 204/456

(57) ABSTRACT

An integrated electrophoresis device includes a passage, a receiving opening, a removal opening, and a set of electric field generators. The passage is provided with gel and buffer solution. The receiving opening is disposed in the passage. The removal opening is also disposed in the passage. The electric field generators generate an electric field in the passage so that a plurality of charged substances in the passage migrates from the receiving opening to the removal opening.

### CROSS REFERENCE TO RELATED APPLICATIONS

This Application claims priority of Taiwan Patent Application No. 97147812, filed on Dec. 9, 2008, the entirety of which is incorporated by reference herein.

### BACKGROUND OF THE INVENTION

1. Field of the Invention

The invention relates to an integrated electrophoresis device and the operation thereof.

2. Description of the Related Art

Recombinant DNA (Deoxyribonucleic Acid) technology requires DNA digestion, electrophoresis, extraction, and ligation, as described in the following:

A restriction enzyme buffer and DNA are disposed in a micro centrifuge tube at 37° C. for 1-2 hours to cut the DNA into fragments.

Loading dye is added to the DNA fragments. Then, the DNA fragments as well as a control group are treated by electrophoresis. The electrophoresis is carried out in a gel box having agarose gel inside (see U.S. Pat. No. 4,737,251 (1985)), wherein the DNA fragments with negative charges migrate from the negatively charged electrode toward the positively charged electrode. When the loading dye is 1.5 cm away from the bottom of the agarose gel, the power supply is terminated.

EtBr (ethidium bromide) can be used for dying DNA. After the electrophoresis, therefore, the agarose gel is disposed in an EtBr solution and vibrated so that dyeing is uniform. Then, the dyed DNA is disposed on a UV (ultraviolet ray) table. The location of the DNA can be identified because EtBr is composed of fluorescent molecules.

The portion of the agarose gel containing the desired DNA fragment is picked by cutting, melted, and disposed in a DNA extraction kit to be purified as a DNA insert by centrifugal force.

The DNA insert, a DNA vector, and a ligase buffer are disposed in a micro centrifuge tube for an ice bath for DNA ligation.

During the operation, however, the operator needs to repeatedly calculate the reaction time, check the progress, and change the environment of the sample. Additionally, the extraction of DNA from the gel requires great efforts. Furthermore, while cutting the gel and extracting the DNA from the gel, the operator has to risk long exposure to ultraviolet rays and contact with fluorescent dye.

To avoid the risks and inconvenient operation, more and more laboratory chips have been developed and disclosed. All the laboratory chips are cross-shaped. For example, a multi electric field electrophoresis chip has been disclosed by David S. Soane et al. in 1996 (U.S. Pat. No. 5,750,015), wherein charged molecules can be moved in a cross electric field to react with other molecules. However, the electric field generated by the cross-shaped chip is complex. Thus, DNA tends to spread at the intersection and a part of the DNA is left in the lateral branch trench. Furthermore, two adjacent DNAs are kept distant from each other to avoid simultaneous arrival at the lateral branch trench. As a result, the time for electrophoresis is required to be long, the gel is susceptible to deformation and melting, and the electrophoresis may not be successful.

### BRIEF SUMMARY OF THE INVENTION

The invention provides an integrated electrophoresis device and an operation thereof, capable of reducing the use of DNA and operating time, and eliminating the need for the operator to perform DNA extraction and be exposed to ultraviolet rays for a long period of time.

The integrated electrophoresis device in accordance with an exemplary embodiment of the invention includes a passage, a receiving opening, a removal opening, and a set of electric field generators. The passage is provided with gel and buffer solution. The receiving opening is disposed in the passage. The removal opening is also disposed in the passage. The electric field generators generate an electric field in the passage so that a plurality of charged substances in the passage migrates from the receiving opening to the removal opening.

In another exemplary embodiment, the integrated electrophoresis device further includes a set of buffer solution reservoirs connected to the passage.

In yet another exemplary embodiment, the integrated electrophoresis device further includes a temperature controller disposed adjacent to the receiving opening to control a temperature in the receiving opening.

In another exemplary embodiment, the electric field generators are partially immersed in the buffer solution.

The invention also provides a process for operating the integrated electrophoresis device. The process in accordance with an exemplary embodiment of the invention includes the steps of: first, providing the integrated electrophoresis device; second, providing the charged substances in the receiving opening; third, generating the electric field so that the charged substances migrate in the passage to separate a desired charged substance therefrom; and fourth, removing the desired charged substance from the removal opening.

The charged substances may be DNA fragments, RNA fragments, or protein fragments.

In another exemplary embodiment, providing the charged substances in the receiving opening includes the steps of: first, proving DNA, RNA, or protein in the receiving opening; second, providing restriction enzyme and the buffer solution in the receiving opening; and third, controlling a temperature in the receiving opening to cut the DNA, RNA, or protein into fragments.

The invention also provides an integrated electrophoresis device. The device in accordance with an exemplary embodiment includes two passages, two receiving openings, a removal opening, and two sets of electric field generators. The passages are provided with gel and buffer solution. The receiving openings are disposed in the passages. The removal opening is disposed in the passages. The electric field generators generate two electric fields in the passages so that a plurality of charged substances in the passages migrates from the receiving openings to the removal opening.

In another exemplary embodiment, the integrated electrophoresis device further includes two sets of buffer solution reservoirs connected to the passages.

In yet another exemplary embodiment, the integrated electrophoresis device further includes a set of temperature controllers disposed adjacent to the receiving openings to control temperature in the receiving openings.

In another exemplary embodiment, the electric field generators are partially immersed in the buffer solution

In yet another exemplary embodiment, the integrated electrophoresis device further includes an injection tube connected to the removal opening.

In another exemplary embodiment, the injection tube is connected to a fluid driver.

The fluid driver may include a pneumatic pump, a screw-type pump, or a peristaltic pump.

In yet another exemplary embodiment, the integrated electrophoresis device further includes a set of temperature controllers disposed adjacent to the removal opening to control a temperature of the removal opening.

The invention also provides a process for operating the integrated electrophoresis device. The process in accordance with an exemplary embodiment of the invention includes the steps of: first, providing the integrated electrophoresis device; second, providing the charged substances in the receiving openings; third, generating the electric fields so that the charged substances migrate in the passages to separate a desired charged substance therefrom; and fourth, removing the desired charged substance from the removal opening.

The charged substances may be DNA fragments, RNA fragments, or protein fragments.

In another exemplary embodiment, providing the charged substances in the receiving openings includes the steps of: first, providing DNA, RNA, or protein in the receiving opening; second, providing restriction enzyme and the buffer solution in the receiving openings; and third, controlling a temperature in the receiving openings to cut the DNA, RNA, or protein into fragments.

In yet another exemplary embodiment, the process of operating an integrated electrophoresis device further includes the step of adding ligase into the removal opening and controlling temperature in the removal opening to combine the charged substances, before removal of the desired charged substance from the removal opening.

In another exemplary embodiment, when the charged substances migrate in the passages, the electric fields are turned on and off so that arrival time of the charged substances at the removal opening is substantially the same.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of an integrated electrophoresis device in accordance with a first embodiment of the invention;

FIG. 2 is a schematic view of an integrated electrophoresis device in accordance with a second embodiment of the invention;

FIG. 3 is a schematic view of an integrated electrophoresis device in accordance with a third embodiment of the invention; and

FIG. 4 is a schematic view of an integrated electrophoresis device in accordance with a fourth embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides an integrated electrophoresis device capable of treating charged substances such as DNA (Deoxyribonucleic Acid), RNA (Ribonucleic Acid), and protein. However, only DNA is used for introducing the invention in the following embodiments:

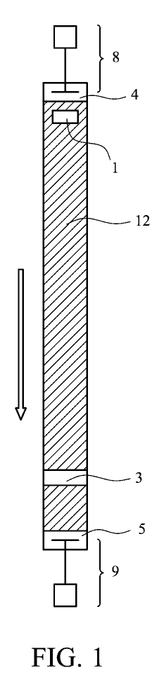

Referring to FIG. 1, an integrated electrophoresis device of a first embodiment includes a receiving opening 1, a removal opening 3, two buffer solution reservoirs 4 and 5, a set of electric field generators 8 and 9, and a passage 12.

The passage 12 is provided with agarose gel. In the first embodiment, the electric field generators 8 and 9 are electrodes which are partially immersed in the buffer solution reservoirs 4 and 5. A buffer solution is injected into the buffer solution reservoirs 4 and 5, the receiving opening 1, and the removal opening 3. DNA fragments are injected into the receiving opening 1. The electric field generator 8 is with negative charge and the electric field generator 9 is with positive charge. Then, an electric field is generated in the passage 12 to move the DNA fragments along the arrow.

During electrophoresis, the DNA fragments are separated from each other. When the desired DNA fragment enters the removal opening 3, the electric field generators 8 and 9 are turned off. Next, the desired DNA fragment is then removed from the removal opening 3.

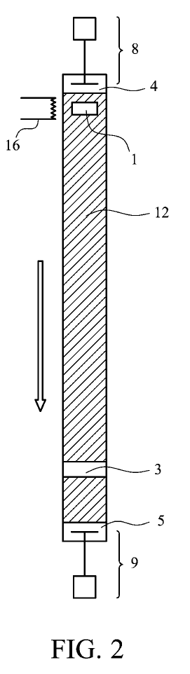

Referring to FIG. 2, an integrated electrophoresis device of a second embodiment includes a receiving opening 1, a removal opening 3, a temperature controller 16, a passage 12, two buffer solution reservoirs 4 and 5, and two electric field generators 8 and 9.

The passage 12 is provided with agarose gel. In the second embodiment, the electric field generators 8 and 9 are electrodes which are partially immersed in the buffer solution reservoirs 4 and 5. A buffer solution is injected into the buffer solution reservoirs 4 and 5, and the removal opening 3. A DNA, restriction enzyme, and a compatible buffer solution are injected into the receiving opening 1. The temperature controller 16 is turned on to control the temperature of the reaction. After the DNA is cut into fragments, the electric field generator 8 is connected to a negatively charged source and the electric field generator 9 is connected to a positively charged source, thus generating an electric field in the passage 12 to move the DNA fragments along the arrow.

During the electrophoresis, the DNA fragments are separated from each other. When the desired DNA fragment enters the removal opening 3, the electric field generators 8 and 9 are turned off. The desired DNA fragment is then removed from the removal opening 3.

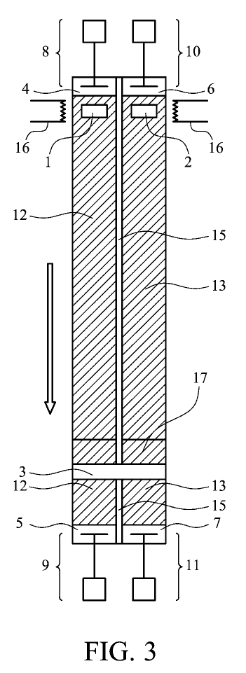

Referring to FIG. 3, an integrated electrophoresis device of a third embodiment includes a removal opening 3, a partition 15, two receiving openings 1 and 2, two temperature controllers 16, two passages 12 and 13, four buffer solution reservoirs 4, 5, 6, and 7, and four electric field generators 8, 9, 10, and 11.

The passages 12 and 13 are divided from each other by the partition 15 and provided with agarose gel. The electric field generators (e.g. electrodes) 8, 9, 10, and 11 are partially immersed in the buffer solution reservoirs 4, 5, 6, and 7 respectively. A buffer solution is injected into the buffer solution reservoirs 4, 5, 6, and 7, and the removal opening 3. A first DNA and a second DNA are injected into the receiving openings 1 and 2. The temperature controller 16 is turned on to control the temperature of the reaction. After the first DNA and the second DNA are cut into fragments, the electric field generators 8 and 10 are connected to a negatively charged source and the electric field generators 9 and 11 are connected to a positively charged source to start electrophoresis. During the electrophoresis, the first DNA fragments and the second DNA fragments are moved along the arrow and separated.

If the desired first DNA fragment arrives at the stop zone 17 earlier than the desired second DNA fragment, then the electric field generators 8 and 9 are turned off. The desired first DNA fragment is held in the stop zone 17 until the desired second DNA fragment arrives at the stop zone 17. Then, the electric field generators 8 and 9 are turned on. On the other hand, the electric field generators 10 and 11 are turned off if the desired second DNA fragment arrives at the stop zone 17 earlier than the desired first DNA fragment. The desired second DNA fragment is held in the stop zone 17 until the desired first DNA fragment arrives at the stop zone 17. Then, the electric field generators 10 and 11 are turned on. Thus, the desired first DNA fragment and the desired second DNA fragment are capable of arriving at the removal opening 3 substantially at the same time.

When the desired first and second DNA fragments enter the removal opening 3, the electric field generators 8, 9, 10, and 11 are turned off. Next, the desired first and second DNA fragments are removed from the removal opening 3.

The operation of the integrated electrophoresis device can be automated by using an image acquisition system to assist the switching of on/off of the electric field generators 8, 9, 10, and 11.

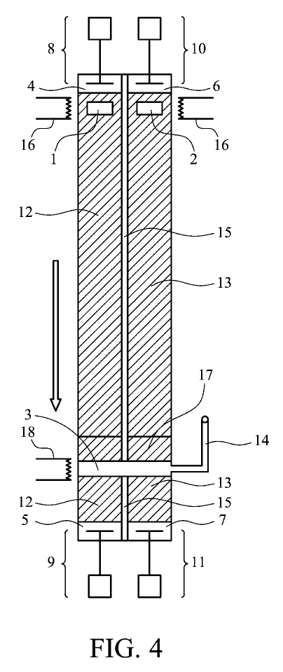

Referring to FIG. 4, an integrated electrophoresis device of a fourth embodiment includes a removal opening 3, a partition 15, two receiving openings 1 and 2, two temperature controllers 16, two passages 12 and 13, four buffer solution reservoirs 4, 5, 6, and 7, four electric field generators 8, 9, 10, and 11, an injection tube 14, and a temperature controller 18.

The passages 12 and 13 are divided from each other by the partition 15 and provided with agarose gel. The electric field generators (e.g. electrodes) 8, 9, 10, and 11 are partially immersed in the buffer solution reservoirs 4, 5, 6, and 7. A buffer solution is injected into the buffer solution reservoirs 4, 5, 6, and 7, and the removal opening 3. A first DNA and a second DNA are injected into the receiving openings 1 and 2. The temperature controller 16 is turned on to control the temperature of the reaction. After the first DNA and the second DNA are cut into fragments, the electric field generators 8 and 10 are connected to a negative voltage and the electric field generators 9 and 11 are connected to a positive voltage to start electrophoresis. During the electrophoresis, the first DNA fragments and the second DNA fragments are moved along the arrow and separated.

If the desired first DNA fragment arrives at the stop zone 17 earlier than the desired second DNA fragment, then the electric field generators 8 and 9 are turned off. The desired first DNA fragment is held in the stop zone 17 until the desired second DNA fragment arrives at the stop zone 17. Then, the electric field generators 8 and 9 are turned on. On the other hand, the electric field generators 10 and 11 are turned off if the desired second DNA fragment arrives at the stop zone 17 earlier than the desired first DNA fragment. The desired second DNA fragment is held in the stop zone 17 until the desired first DNA fragment arrives at the stop zone 17. Then, the electric field generators 10 and 11 are turned on. Thus, the desired first DNA fragment and the desired second DNA fragment are capable of arriving at the removal opening 3 substantially at the same time.

When the desired first and second DNA fragments enter the removal opening 3, the electric field generators 8, 9, 10, and 11 are turned off. Ligase is injected into the removal opening 3 through the injection tube 14 and the temperature controller 18 is turned on to control the temperature of the reaction so as to combine the desired first and second DNA fragments. Then, the combined DNA is removed from the removal opening 3.

The injection tube 14 is connected to a fluid driver which may be a pneumatic pump, a screw-type pump, or a peristaltic pump, for injecting ligase into the removal opening 3.

The operation of the integrated electrophoresis device can be automated by using an image acquisition system to assist the switching of on/off of the electric field generators 8, 9, 10, and 11.

The integrated electrophoresis device of the invention is capable of reducing the consumption of DNA and operating time, and eliminating the need for the operator to perform DNA extraction and be exposed to ultraviolet rays for a long period of time. To avoid the drawback of cross-type electrophoresis, two parallel straight passages are provided in the fourth embodiment. Additionally, the operation is automatic, requiring fewer experiment checks. Specifically, the process of the operation does not require manual labor and the operator only needs to check the experiment before and after the reaction. Thus, the operation is convenient, safe, and efficient.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An integrated electrophoresis device, comprising:
a passage provided with gel and buffer solution;
a receiving opening disposed in the passage;
a removal opening also disposed in the passage; and
a set of electric field generators generating an electric field in the passage so that a plurality of charged substances in the passage migrates from the receiving opening to the removal opening.

2. The integrated electrophoresis device as claimed in claim 1, further comprising a set of buffer solution reservoirs connected to the passage.

3. The integrated electrophoresis device as claimed in claim 1, further comprising a temperature controller disposed adjacent to the receiving opening to control a temperature in the receiving opening.

4. The integrated electrophoresis device as claimed in claim 1, wherein the electric field generators are partially immersed in the buffer solution.

5. A process for operating an integrated electrophoresis device, comprising:
providing the integrated electrophoresis device of claim 1;
providing the charged substances in the receiving opening;
generating the electric field so that the charged substances migrate in the passage to separate a desired charged substance therefrom; and
removing the desired charged substance from the removal opening.

6. The process for operating an integrated electrophoresis device as claimed in claim 5, wherein the charged substances comprising DNA fragments, RNA fragments, or protein fragments.

7. The process for operating an integrated electrophoresis device as claimed in claim 5, wherein providing the charged substances in the receiving opening comprises:
proving DNA, RNA, or protein in the receiving opening;
providing restriction enzyme and the buffer solution in the receiving opening; and
controlling a temperature in the receiving opening to cut the DNA, RNA, or protein into fragments.

8. An integrated electrophoresis device, comprising:
two passages provided with gel and buffer solution;
two receiving openings disposed in the passages;
a removal opening disposed in the passages; and
two sets of electric field generators generating two electric fields in the passages so that a plurality of charged substances in the passages migrates from the receiving openings to the removal opening.

9. The integrated electrophoresis device as claimed in claim 8, further comprising two sets of buffer solution reservoirs connected to the passages.

10. The integrated electrophoresis device as claimed in claim 8, further comprising a set of temperature controllers disposed adjacent to the receiving openings to control temperature in the receiving openings.

11. The integrated electrophoresis device as claimed in claim 8, wherein the electric field generators are partially immersed in the buffer solution.

12. The integrated electrophoresis device as claimed in claim 8, further comprising an injection tube connected to the removal opening.

13. The integrated electrophoresis device as claimed in claim 12, wherein the injection tube is connected to a fluid driver.

14. The integrated electrophoresis device as claimed in claim 13, wherein the fluid driver includes a pneumatic pump, a screw-type pump, or a peristaltic pump.

15. The integrated electrophoresis device as claimed in claim 8, further comprising a set of temperature controllers disposed adjacent to the removal opening to control a temperature of the removal opening.

16. A process for operating an integrated electrophoresis device, comprising:
providing the integrated electrophoresis device of claim 8;
providing the charged substances in the receiving openings;
generating the electric fields so that the charged substances migrate in the passages to separate a desired charged substance therefrom; and
removing the desired charged substance from the removal opening.

17. The process for operating an integrated electrophoresis device as claimed in claim 16, wherein the charged substances include DNA fragments, RNA fragments, or protein fragments.

18. The process for operating an integrated electrophoresis device as claimed in claim 17, wherein providing the charged substances in the receiving openings comprises:
proving DNA, RNA, or protein in the receiving opening;
providing restriction enzyme and the buffer solution in the receiving openings; and
controlling a temperature in the receiving openings to cut the DNA, RNA, or protein into fragments.

19. The process for operating an integrated electrophoresis device as claimed in claim 17, further comprising adding ligase into the removal opening and controlling temperature in the removal opening to combine the charged substances, before removal of the desired charged substance from the removal opening.

20. The process for operating an integrated electrophoresis device as claimed in claim 16, wherein when the charged substances migrate in the passages, the electric fields are turned on and off so that arrival time of the charged substances at the removal opening is substantially the same.
